(19) United States
(12) Patent Application Publication
(10) Pub. No.: US 2025/0214769 A1
(43) Pub. Date: Jul. 3, 2025

(54) REFUSE VEHICLE WITH MODULAR BODY COMPONENTS

(71) Applicant: Oshkosh Corporation, Oshkosh, WI (US)

(72) Inventors: Jerrod Kappers, Oshkosh, WI (US); Aaron Hardy, Oshkosh, WI (US); Jacob Solberg, Oshkosh, WI (US); Nick Weykamp, Oshkosh, WI (US); Alec Ehlke, Oshkosh, WI (US); Vince Schad, Oshkosh, WI (US); Quincy Wittman, Oshkosh, WI (US); Jeff Meyer, Oshkosh, WI (US); Troy Meyers, Oshkosh, WI (US)

(73) Assignee: Oshkosh Corporation, Oshkosh, WI (US)

(21) Appl. No.: 19/004,147

(22) Filed: Dec. 27, 2024

Related U.S. Application Data
(60) Provisional application No. 63/615,739, filed on Dec. 28, 2023.

(51) Int. Cl. B65F 3/00

(52) U.S. Cl. CPC B65F 3/00; B65F 2003/006

(57) ABSTRACT

A refuse vehicle with modular elements that permit the body of the refuse vehicle to be changed and expanded. The refuse vehicle that includes a chassis and a refuse containment body coupled to the chassis that defines a refuse compartment. The refuse containment body includes a hopper mating portion at a first end of the refuse compartment and configured to couple to a hopper for loading the refuse containment body and a containment wall mating portion at a second end of the refuse compartment and configured to couple to a containment member.

### CROSS-REFERENCE TO RELATED APPLICATIONS

This application claims the benefit of and priority to U.S. Provisional Application No. 63/615,739, filed Dec. 28, 2023, the entire contents of which are hereby incorporated by reference herein.

### BACKGROUND

The present disclosure relates generally to the field of refuse vehicles. More specifically, the present disclosure relates to refuse container and hopper structures for refuse vehicles.

### SUMMARY

One embodiment of the present disclosure relates to a refuse vehicle that includes a chassis and a refuse containment body coupled to the chassis. The refuse containment body defines a refuse compartment. The refuse containment body includes a first body section and at least a second body section. The second body section includes either a hopper or a volume expansion section positioned at a first end of the first body section. At the first end, the first body section includes a first opening configured with a mating interface coupled with a mating interface of the second body section. At a second end of the first body section, the first body section includes a second opening configured with a mating interface coupled with a mating interface of a third body section.

Another embodiment relates to a refuse vehicle that further includes a modular element, such as a wall, floor, roof, or other panel, couplable to the refuse containment body so as to expand a volume of the refuse containment body.

Another embodiment relates to a refuse containment body that includes a floor, cover, and sidewalls, wherein at least one is comprised of multiple panels.

Another embodiment relates to a refuse vehicle with a refuse containment body that is a refuse containment body. The refuse containment body can be used with front-loading, side-loading, and rear-loading refuse vehicles.

Another embodiment relates to a refuse vehicle that includes a hopper coupled to a refuse containment body at a hopper mating portion. The refuse containment body including a first track disposed within the refuse compartment, the hopper mating portion including a second track in alignment with the first track at the hopper mating portion.

Another embodiment relates to a refuse vehicle of claim with a refuse containment body that includes a roof panel and a sidewall panel that is coupled to the roof panel in a tab-in-slot arrangement.

Another embodiment relates to a refuse vehicle with at least one of a roof panel or a sidewall panel that includes a sealing member extending along an edge thereof and is engaged with either one of the roof panel or the sidewall panel when the roof panel is coupled to the sidewall panel.

Another embodiment relates to a refuse vehicle, further including a hopper and a containment member. The hopper and the containment member are coupled to the refuse containment body on opposing ends of the refuse containment body using mechanical fasteners.

Another embodiment relates to a refuse vehicle in which at least one of the hoppers or the containment member are coupled to the refuse containment body using at least one of: tabs; bolts; rivets; adhesive; weld; T-Nuts; latches; locks; or pins.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 is a perspective view of a front-loading refuse vehicle, according to an exemplary embodiment;

FIG. 2 is a side view of a rear-loading refuse vehicle, according to an exemplary embodiment;

FIG. 3 is a perspective view of a side-loading refuse vehicle, according to an exemplary embodiment;

FIG. 4A is a perspective view of a front-loading refuse vehicle with a refuse containment body, according to an exemplary embodiment;

FIG. 4B is a perspective view of a rear-loading refuse vehicle with a refuse containment body, according to an exemplary embodiment;

FIG. 4C is a perspective view of a side-loading refuse vehicle with a refuse containment body, according to an exemplary embodiment;

FIG. 5 is an exploded perspective view of a front-loading modular refuse vehicle that includes a refuse containment body with a hopper mating portion and a containment wall mating portion, according to an exemplary embodiment;

FIG. 6 is an exploded perspective view of a rear-loading modular refuse vehicle that includes a refuse containment body with a hopper mating portion and a containment wall mating portion, according to an exemplary embodiment;

FIG. 7 is an exploded perspective view of a side-loading modular refuse vehicle that includes a refuse containment body with a hopper mating portion and a containment wall mating portion, according to an exemplary embodiment;

FIG. 8 is a perspective view of a rear-loading expanded refuse vehicle with a volume expansion section, according to an exemplary embodiment;

FIG. 9 is an exploded side view of a rear-loading expanded refuse vehicle with a volume expansion section, according to an exemplary embodiment;

FIG. 10 is an exploded side view of a side-loading refuse vehicle rear-loading refuse vehicle with a volume expansion section, according to an exemplary embodiment;

FIG. 11 is a perspective internal view of a front-loading refuse vehicle equipped with a modular ejector assembly, according to an exemplary embodiment;

FIG. 12 is a perspective internal view of a front-loading refuse vehicle equipped with a modular ejector assembly in a retracted position, according to an exemplary embodiment;

FIG. 13 is a perspective internal view of a rear-loading refuse vehicle equipped with a modular ejector assembly, according to an exemplary embodiment;

FIG. 14 is a perspective internal view of a rear-loading refuse vehicle equipped with a modular ejector assembly in a retracted position, according to an exemplary embodiment;

FIG. 15 is a perspective internal view of a side-loading refuse vehicle equipped with a modular ejector assembly, according to an exemplary embodiment;

FIG. 16 is a perspective internal view of a side-loading refuse vehicle equipped with a modular ejector assembly in a retracted position, according to an exemplary embodiment;

FIG. 17 is a perspective view of a fixed top panel for a front-loading refuse vehicle, according to an exemplary embodiment;

FIG. 18 is a perspective view of a curved top panel for a rear-loading refuse vehicle, according to an exemplary embodiment;

FIG. 19 is a perspective view of a follower panel for a side-loading refuse vehicle, according to an exemplary embodiment;

FIG. 20 is a perspective view of a common eject base coupled to engaging tracks, according to an exemplary embodiment;

FIG. 21A is a perspective view of a refuse containment body shown during a first phase of assembly using a tab-and-slot arrangement, according to an exemplary embodiment;

FIG. 21B is a perspective view of the refuse containment body of FIG. 21A in a second phase of assembly, according to an exemplary embodiment;

FIG. 21C is a perspective view of the refuse containment body of FIG. 21A in a third phase of assembly, according to an exemplary embodiment;

FIG. 22 is a perspective view of a deformable tab structure used to couple body sections, according to an exemplary embodiment;

FIG. 23 is a perspective view of a drop-in style T-nut assembly for coupling, according to an exemplary embodiment;

FIG. 24 is a perspective view of an assembly for coupling using T-nuts, according to an exemplary embodiment;

FIG. 25A is a perspective view of a T-nut assembly in a first phase of assembly, according to an exemplary embodiment;

FIG. 25B is a perspective view of a T-nut assembly in a second phase of assembly, in which a T-nut is inserted into a T-track, according to an exemplary embodiment;

FIG. 25C is a perspective view of a T-nut assembly in a third phase of assembly, in which a set screw is screwed into a T-nut to keep it in place on a T-track during the assembly process, according to an exemplary embodiment;

FIG. 25D is a perspective view of a T-nut assembling in a fourth phase of assembly, in which a screw cap is inserted through a hole in the walling of a refuse vehicle component, according to an exemplary embodiment;

FIG. 26 is an exploded perspective view of a refuse vehicle containing T-tracks and holes for securing a refuse containment body to a hopper section, according to an exemplary embodiment;

FIG. 27A is a side view of a double-sided groove weld to seal a coupling between a first body section and a second body section, according to an exemplary embodiment;

FIG. 27B is a side view of a single-sided groove weld to seal a coupling between a first body section and a second body section, according to an exemplary embodiment;

FIG. 27C is a side view of a gasket weld to seal a coupling between the first body section and the second body section, according to an exemplary embodiment;

FIG. 27D is a side view of a tongue and groove joint to seal a coupling between the first body section and the second body section, according to an exemplary embodiment; and

FIG. 28 is a flowchart of a process of assembling a refuse vehicle according to an exemplary embodiment; and

FIG. 29 is a side view of a multi-section ejector track for a refuse vehicle, according to an exemplary embodiment.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

Referring generally to the FIGURES, a refuse collection vehicle is shown that includes a modular refuse containment body (e.g., a refuse containment body, a refuse containment member, body section etc.) coupled to a refuse collection hopper and a containment structure, such as an end wall or tailgate, according to an exemplary embodiment. The modular refuse containment body may be common across a plurality of refuse vehicle types (e.g. front-loading, side loading, or rear loading), and, according to an exemplary embodiment, may be adjustable in length and/or volume by coupling additional or different sections to the refuse containment body. This may increase the capacity of the modular refuse containment body by expanding the overall volume of the refuse containment body. In exemplary embodiments, the modular refuse containment body is reversible on a chassis of the refuse vehicle and may be mounted at different longitudinal positions along the chassis to support different vehicle configurations (e.g., loading configurations, etc.). As used herein, the term “refuse containment body” means any of or any combination of: containment walls, hopper volumes, tailgates, or volume expansion sections.

In exemplary embodiments, the modular refuse containment body may contain internal tracks for guiding a common eject base and mounted top panel, which, in combination, form a modular ejector, according to an exemplary embodiment. In exemplary embodiments, the tailgate of the refuse collection vehicle may also be modular. The modular tailgate may also accommodate different volumes of collected materials by coupling additional or different sections to the modular tailgate. The refuse collection hopper and/or the containment member (e.g., modular body components) may be mounted to the refuse containment body using mechanical fasteners, which simplifies assembly and permits for replacement and/or retrofit of different components during servicing and/or for fleet upgrade. The modular body components (and/or wall panels of the refuse containment body itself) may be sealably engaged to the refuse containment body using a plurality of methods, for example: sheet-to-sheet pressure, gaskets, or grooves.

### Refuse Vehicle

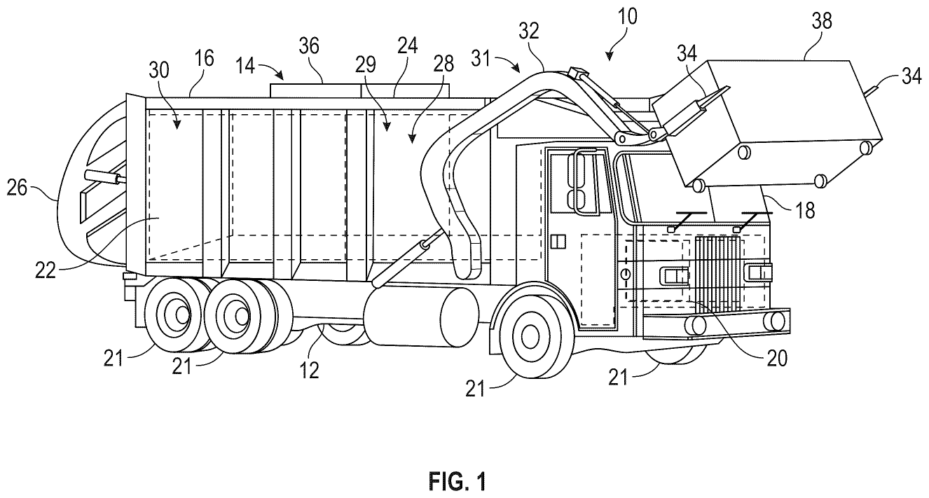

Referring to FIGS. 1-3, a refuse vehicle (e.g., garbage truck, waste collection truck, sanitation truck, etc.), includes a chassis, shown as a frame 12, and a body assembly, shown as body 14, coupled to the frame 12. The body 14 defines an on-board receptacle 16 and a cab 18. The cab 18 is coupled to a front end of the frame 12 and includes various components to facilitate operation of the refuse vehicle by an operator (e.g., a seat, a-steering wheel, hydraulic controls, etc.) as well as components to control subsystems within the vehicle (e.g., computers, controllers, processing units, etc.). The refuse vehicle further includes a prime mover 20, coupled to the frame 12 at a position beneath the cab 18. The prime mover 20 provides power to a plurality of tractive elements, shown as wheels 21, and to other systems of the vehicle (e.g., a pneumatic system, a hydraulic system, etc.). In exemplary embodiments, the prime mover 20 is an engine configured to run on one or more of a variety of fuels (e.g., gasoline, diesel, bio-diesel, ethanol, natural gas, etc.). The engine may receive a fuel from a tank through one or more fuel lines. In exemplary embodiments, the prime mover includes one or more electric motors coupled to the frame 12. The electric motor(s) may consume electrical power from an on-board energy storage device (e.g., one or more batteries, ultra-capacitors, hydraulic storage devices, etc.), from an on-board generator (e.g., an internal combustion engine and alternator), and/or from an external power source (e.g., overhead power lines, power rails, etc.) and provide power to the systems of the refuse vehicle. The prime mover 20 may transfer output torque to or drive the tractive elements 20 (e.g., wheels, wheel assemblies, etc.) of the refuse vehicle through a transmission. The prime mover 20 along with various component such as a transmission, one or more shafts, axles, and gearboxes may define a driveline of the refuse vehicle.

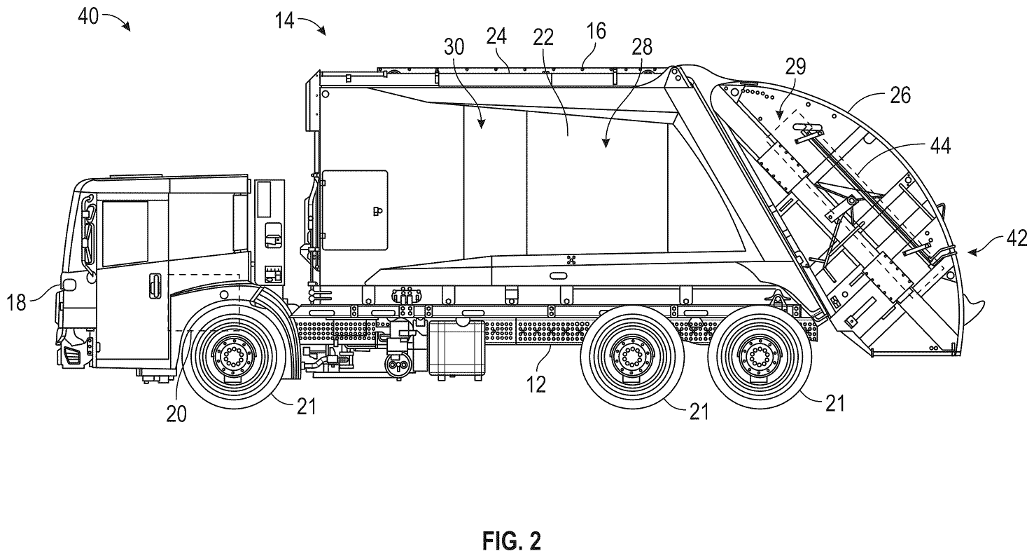

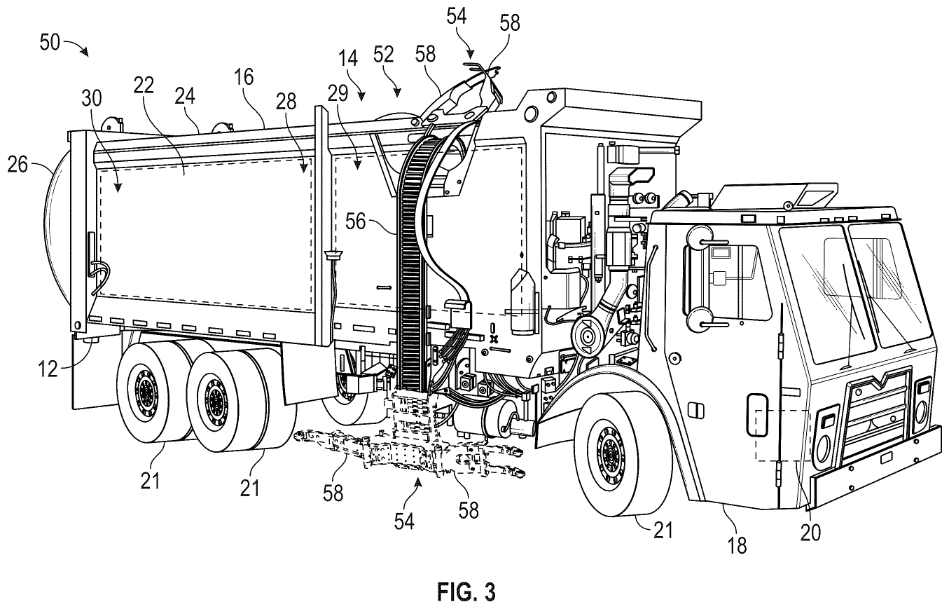

According to an exemplary embodiment, the refuse vehicle is configured to transport refuse from various waste receptacles within a municipality to a storage or processing facility (e.g., a landfill, an incineration facility, a recycling facility, etc.). The body 14 and the on-board receptacle 16, in particular, include a series of panels, shown as panels 22, a cover 24, and a tailgate 26. The panels 22, cover 24, and tailgate 26 define a refuse compartment 28 of the on-board receptacle 16. Loose refuse is placed into the refuse compartment 28, where it may be thereafter compacted. The refuse compartment 28 provides temporary storage for refuse during transport to a waste disposal site or a recycling facility, for example. In exemplary embodiments, at least a portion of the on-board receptacle 16 and refuse compartment 28 extend over or in front of the cab 18. In exemplary embodiments, the refuse compartment 28 includes a hopper volume 29 and a storage volume 30. Refuse is initially loaded into the hopper volume 29 and thereafter compacted into the storage volume 30. According to an exemplary embodiment, the hopper volume 29 is positioned between the storage volume and the cab 18 (i.e., refuse is loaded into a position behind the cab 18 and stored in a position further toward the rear of the refuse vehicle). The refuse vehicle can be arranged as a front-loading refuse vehicle 10 (shown in FIG. 1), a rear-loading refuse vehicle 40 (shown in FIG. 2), or a side-loading refuse vehicle (shown in FIG. 3) for example.

The tailgate 26 may be hingedly or pivotally coupled with the body 14 at a rear end of the body 14 (e.g., opposite the cab 18). The tailgate 26 may be driven to rotate between an open position and a closed position by tailgate actuators. The refuse compartment 28 may be hingedly or pivotally coupled with the frame 12 such that the refuse compartment 28 can be driven to raise or lower while the tailgate 26 is open in order to dump contents of the refuse compartment 28 at a landfill. The refuse compartment 28 may include a packer assembly (e.g., a compaction apparatus) positioned therein that is configured to compact loose refuse.

In exemplary embodiments, sections of the body 14 (e.g., cab 18, on-board receptacle 16, tailgate 26, refuse compartment 28, etc.) are fixedly coupled to the chassis or the frame 12 by support element such as bolts, rivets, adhesive, weld, T-Nuts, formed tab-in-slot, latches, locks, deformable tabs, keyways/keyed, pins, cam-locking pins, or any combination thereof. In exemplary embodiments, a body section is configured with a mounting plate, fasteners, and a spring assembly to couple with the frame 12 as described in U.S. patent application Ser. No. 18/810,250, filed on Aug. 20, 2024, the entire disclosure of which is incorporated by reference herein.

In exemplary embodiments, the body sections or subsections of a body section may be made up of multiple individual panels that are bolted or otherwise mechanically fastened to together. An individual panel may be unfastened from the other individual panels or may be differ in configuration (e.g., size, dimensions, shape, material, etc.) than the other individual panels. For example, the tailgate 26 may be made up of a two side panels and a rear panel that are bolted together. In such embodiment, if one side panel is dented, that side panel may be unbolted from the tailgate 26 and replaced with an undented panel. In exemplary embodiments, one side wall of the on-board receptacle 16 may be made of multiple panels. The panels that make up the one side wall may vary in size, thickness, or material to achieve different purposes (e.g., thicker panels for areas of the side wall that are often damaged or dented more often or quicker).

### Front-Loading Configuration

Referring to FIG. 1, a perspective view of a front-loading refuse vehicle 10 is shown according to an exemplary embodiment. In the exemplary embodiment, the on-board receptacle 16 and refuse compartment 28 are each positioned behind the cab 18. The prime mover 20 provides power to a lift mechanism or system. The front-loading refuse vehicle 10 includes the lift mechanism or system (e.g., a front-loading lift assembly, etc.), shown as lift assembly 31. The lift assembly 31 includes a pair of arms, shown as lift arms 32, coupled to at least one of the frame 12 or the body 14 on either side of the front-loading refuse vehicle 10 such that the lift arms 32 extend forward of the cab 18 (e.g., a front-loading refuse vehicle, etc.). The lift arms 32 may be rotatably coupled to the frame 12 with a pivot (e.g., a lug, a shaft, etc.). The lift assembly 31 includes first actuators, shown as lift arm actuators (e.g., hydraulic cylinders, etc.), coupled to the frame 12 and the lift arms 32. The lift arm actuators are positioned such that extension and retraction thereof rotates the lift arms 32 about an axis extending through the pivot, according to an exemplary embodiment. Lift arms 32 may be removably coupled to a container, shown as refuse container 38 in FIG. 1. Lift arms 32 are configured to be driven to pivot by lift arm actuators to lift and empty the refuse container 38 into the hopper volume for compaction and storage. The lift arms 32 may be coupled with a pair of forks 34 or elongated members that are configured to removably couple with the refuse container 38 so that the refuse container 38 can be lifted and emptied. The refuse container 38 may be similar to the container attachment 38 as described in greater detail in U.S. application Ser. No. 17/558,183, filed Dec. 12, 2021, the entire disclosure of which is incorporated by reference herein. According to an exemplary embodiment, a top door 36 is slid along the cover 24 to seal the opening thereby preventing refuse from escaping the collection chamber 28 (e.g., due to wind, etc.).

In exemplary embodiments, the floor of the on-board receptacle 16 may be made up of multiple panels. For example, thicker panels or more durable materials may be installed in the areas of the floor where refuse is emptied onto when the lift assembly 31 empties a refuse container 38 into the on-board receptacle 16.

### Rear-Loading Configuration

Referring to FIG. 2, a side view of a rear-loading refuse vehicle 40 is shown according to an exemplary embodiment. In the exemplary embodiment, the on-board receptacle 16 and refuse compartment 28 are each positioned behind the cab 18. In the rear-loading embodiment of the refuse vehicle, the tailgate 26 defines an opening 42 through which loose refuse may be loaded into the refuse compartment 28. The tailgate 26 may also include a packer 44 (e.g., a packing assembly, a compaction apparatus, a claw, a hinged member, etc.) that is configured to draw refuse into the refuse compartment 28 for storage. Similar to the embodiment of the front-loading refuse vehicle 10 described in FIG. 1 above, the tailgate 26 may be hingedly coupled with the refuse compartment 28 such that the tailgate 26 can be opened or closed during a dumping operation. In such embodiment, the hopper volume 29 is integrated into the tailgate 26.

### Side-Loading Configuration

Referring to FIG. 3, a perspective view of a side-loading refuse vehicle 50 is shown (e.g., a zero-radius side-loading refuse vehicle) according to an exemplary embodiment. The side-loading refuse vehicle 50 includes a lift mechanism or system, shown as lift assembly. Lift assembly 52 includes a grabber assembly, shown as grabber assembly 54, movably coupled to a track, shown as track 56, and configured to move along an entire length of the track 56. According to the exemplary embodiment shown in FIG. 3, the track 56 extends along substantially an entire height of the body 14 or a component of the body 14 (e.g., on-bard receptacle 16, refuse compartment 28, hopper volume 29, etc.) and is configured to cause the grabber assembly 52 to tilt near an upper height of the body 14. In other embodiments, the track 56 extends along substantially an entire height of body 14 on a rear side of body 14. The side-loading refuse vehicle 50 can also include a reach system or assembly coupled with the body 14 or the frame 12 of the side-loading refuse vehicle 50 and the lift assembly 52. The reach system can include telescoping members, a scissors stack, etc., or any other configuration that can extend or retract to provide additional reach of the grabber assembly 54 for refuse collection.

Referring still to FIG. 3, the grabber assembly 54 includes a pair of grabber arms shown as grabber arms 5. The grabber arms 58 are configured to rotate about an axis extending through a bushing. The grabber arms 58 are configured to releasably secure a refuse container to grabber assembly 54, according to an exemplary embodiment. The grabber arms 54 rotate about the axis extending through the bushing to transition between an engaged state (e.g., a fully grasped configuration, a fully grasped state, a partially grasped configuration, a partially grasped state) and a disengaged state (e.g., a fully open state or configuration, a fully released state/configuration, a partially open state or configuration, a partially released state/configuration). In the engaged state, the grabber arms 58 are rotated towards each other such that the refuse container is grasped therebetween. In the disengaged state, the grabber arms 58 rotate outwards such that the refuse container is not grasped therebetween. By transitioning between the engaged state and the disengaged state, the grabber assembly 54 releasably couples the refuse container with grabber assembly 54. The side-loading refuse vehicle 50 may pull up along-side the refuse container, such that the refuse container is positioned to be grasped by the grabber assembly 54 therebetween. The grabber assembly 54 may then transition into an engaged state to grasp the refuse container. After the refuse container has been securely grasped, the grabber assembly 54 may be transported along the track 56 with the refuse container. When the grabber assembly 54 reaches the end of track 56, the grabber assembly 54 may tilt and empty the contents of the refuse container in the refuse compartment 28. The tilting is facilitated by the path of the track 56. When the contents of the refuse container have been emptied into the refuse compartment 28, the grabber assembly 54 may descend along the track 56 and return the refuse container to the ground. Once the refuse container has been placed on the ground, the grabber assembly 54 may transition into the disengaged state, releasing the refuse container.

In exemplary embodiments, the side wall of the on-board receptacle 16 opposite the grabber assembly 54 may be made up of multiple panels. For example, thicker panels or more durable materials may be installed in the areas of the sidewall where refuse is emptied onto when the grabber assembly 54 empties refuse into the on-board receptacle 16.

Refuse Vehicles with Modular Body Sections

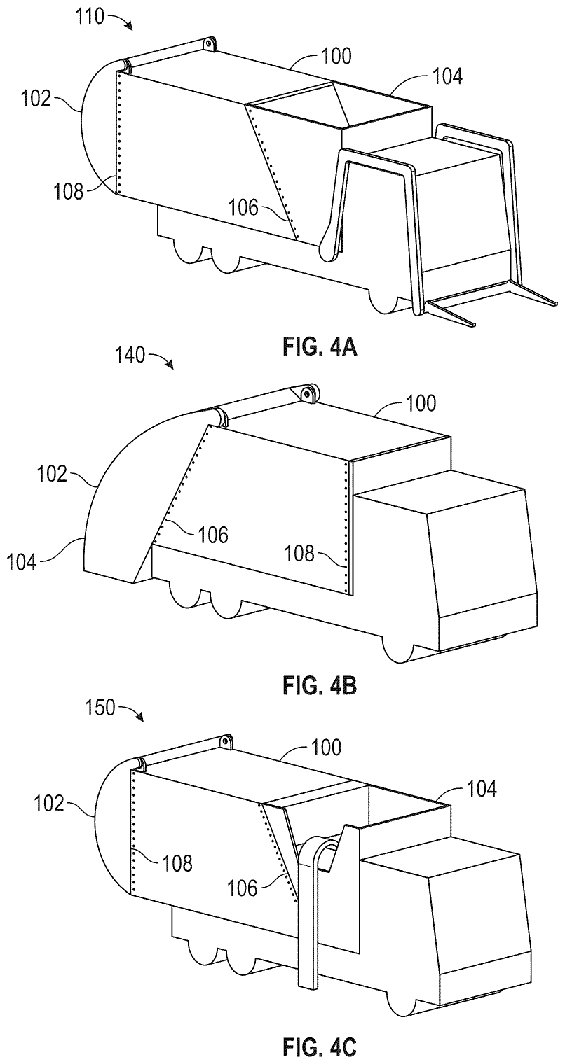

Referring to FIGS. 4-7, three different types of refuse vehicles are shown all with a refuse containment body 100. FIGS. 4A, 4B, and 4C show perspective views of a front-loading, rear-loading, and side-loading refuse vehicles, each with a refuse containment body 100, according to an exemplary embodiment. Modular refuse vehicles may include body sections (e.g., cab 18, on-board receptacle 16, tailgate 26, refuse compartment 28, etc.) and be configured similarly to the refuse vehicles of FIGS. 1-3. The refuse containment body 100 may be a single component that is a single weldment in exemplary embodiments. In other embodiments, the refuse containment body 100 is formed from a plurality of wall panels that are coupled together using a tab-in-slot arrangement or other types of mechanical fasteners, as will be further described. The refuse containment body 100 may form a compartment (e.g., the refuse compartment 28, the storage volume 30, etc.) according to an exemplary embodiment. In an exemplary embodiment, a body section may include a mating portion that includes an opening of the body section and a mating interface at an axial end of the body section.

The refuse containment body 100 may include a series of panels to form a compartment. The refuse containment body 100 may contain a top portion (e.g. a roof) and a bottom portion that are substantially horizontal and are arranged in parallel to one another as well as a ground plane. The bottom portion may include flooring or may be an opening. The refuse containment body 100 may also include a plurality of sidewalls extending between the top wall and the bottom wall, that together with the sidewalls define openings at each longitudinal end of the refuse containment body 100. The refuse containment body 100 may serve a variety of refuse vehicles with differing chassis configurations. In exemplary embodiments, a first opening (e.g., perimeter edges of the first opening defined by the refuse containment body 100) at a first axial end of the refuse containment body 100 extends along a reference plane oriented substantially perpendicular to the bottom portion (e.g., the floor) of the refuse containment body 100, while the second opening at the second axial (opposing) end of the refuse containment body 100 extends at an angle relative to the bottom portion (e.g., the floor) of the refuse containment body 100. In exemplary embodiments, the first opening and second opening may be formed along perpendicular axes or planes. The edges that form an opening may be perpendicular, parallel, or intersecting with an axis forming an opening that may be perpendicular, diagonal, slanted, oblique, inclined, or other orientation relative to a plane or axis.

The refuse containment body 100 (e.g., a refuse containment member) and other body sections (e.g., permanent or temporary refuse storage) may be mounted to the chassis in different arrangements and/or orientations to support different refuse vehicle configurations (e.g., front load, side load, rear load, etc.). The refuse containment body 100 defines a refuse compartment configured to receive and store waste material therein. The refuse containment body may be mounted in multiple positions along the chassis of the refuse vehicle. The refuse containment body 100 may be used on each of the three types of refuse vehicles in FIGS. 4A, 4B, and 4C. For example, the second opening may be positioned forward of the first opening (e.g., adjacent to the cab) to accommodate a forward hopper for a front load refuse vehicle or a side load refuse vehicle. The second opening may be positioned aft (e.g., rearward) of the first opening in rear load refuse vehicle arrangements. Stated differently, the orientation of the refuse containment body 100 may be reversible to accommodate different refuse vehicle loading configurations. The refuse containment body 100 contains a variety of edges that may be mounted or coupled to the chassis of the refuse vehicles in a variety of manners.

In exemplary embodiments, the refuse containment body 100 is a common component that may be put in place of a refuse compartment 28 or other body section as depicted in FIGS. 1-3. The refuse containment body 100 may permit front-loading, rear-loading, and side-loading configurations of a refuse vehicle to be volumetrically expanded by adding other body sections between a containment wall mating portion 108 (e.g., a containment wall mating opening, etc.) to a hopper mating portion 10. The modular body sections (e.g. the refuse containment body 100, tailgate body 102, hopper volume body 104, volumetric expansion section) may be coupled to one another, or non-modular components of refuse vehicles by a number of mating mechanisms. In exemplary embodiments, the refuse vehicle components may be coupled together by bolts, rivets, adhesive, weld, T-Nuts, formed tab-in-slot, latches, locks, deformable tabs, keyways/keyed, pins, cam-locking pins, or any mating mechanism. After modular body components are coupled to a refuse vehicle, the seams between the added parts may be sealed using sheet-to-sheet pressure, gaskets, compressible materials such as single sided grooves, double sided grooves or tongue and grooves, or sealing materials such as rubber, polymer, soft metals (e.g. tin, aluminum), deformable shape sealing, or other sealing mechanism. A first body section and a second body section may be configured with interfaces or complements of a mating mechanism or sealing mechanism to mate or seal the first body section and second body section together. Furthermore, a first mating interface or complement and a second interface or complement may be configured to form a mating mechanism when coupled together. For example, the first body section may include holes at an edge and the second body section may include holes at an edge to permit bolts or rivets to mate the first body section and the second body section together. In another example, a first body section may include grooves and a second body section may include tongues or protrusions to seal the first body section and the second body section.

The welding seams for the sidewalls, floor, and roof of the refuse vehicle, as well as between the refuse containment body and other body sections (e.g., hoppers, extension sections, and/or other components connected to the refuse containment body 100 at the first and second openings, etc.) may be sealed using a variety of methods (e.g. sheet-to-sheet pressure, sealing members (e.g., gaskets, compressible materials, sealing materials such as rubber, polymer, soft metals, deformable shape sealing members, etc.) that are disposed within and extend along perimeter edges of the first and second openings, etc. For example, the perimeter edges of the first and second openings may define c, slots, or other recessed areas extending along the perimeter of the openings to receive a sealing member therein.

The bottom portion (e.g., the floor) of the refuse containment body 100 as well as the opposing ends may have edges configured to be coupled to refuse vehicle components. For example, the bottom portion may be affixed to the chassis by welding the bottom portion edge to the chassis or affixing fasteners. The bottom portion may be coupled to the chassis by a number of the previously mentioned coupling methods of FIGS. 1-3.

In an exemplary embodiment, the refuse containment body 100 include multiple panels that form a compartment (e.g., storage volume 30) with two axial ends opposite along a longitudinal axis of the refuse containment body 100. The first axial end may be configured as a hopper mating portion 106. The hopper mating portion 106 may include a first opening of the refuse containment body 100. In exemplary embodiments, the edges of the first opening are configured to mate with a hopper volume body 104 (e.g., hopper volume 29) or a tailgate body 102 (e.g., tailgate 26). For example, the edges of the first opening include a first mating interface such as a T-track and the edges of the hopper volume body 104 may include a mating interface such as a hole for a T-nut. Additionally, the shape and dimensions of the first opening and a mating portion of the hopper volume body 104 are configured create a compartment. For example, the edges of the first opening may form an outwardly downward slanted opening and the edges of the hopper volume body 104 may have an outwardly upward slant. The second axial end may be configured as a containment wall mating portion 108. The containment wall mating portion 108 may include a second opening of the refuse containment body 100. In exemplary embodiments, the edges of the second opening are configured to mate with a panel (e.g., refuse compartment body panel) or a tailgate body 102 (e.g., tailgate 26). For example, the edges of the second opening include a second mating interface such as a T-track and the edges of the tailgate body 102 may include a mating interface such as a hole for a T-nut. Additionally, the shape and dimensions of the second opening and a mating portion of the tailgate body 102 are configured create a compartment. For example, the edges of the second opening and the tailgate body may form planes perpendicular to the longitudinal plane. In exemplary embodiments, the hopper volume body 104 and the tailgate volume body are 102 are combined into a single apparatus. In an exemplary embodiment, the hopper volume body 104 and the tailgate body 102 includes openings at the mating portion configured to mate or couple with the refuse containment body 100.

In exemplary embodiments, the opposing ends may include tab-in-slot mounts or another type of mount arrangement extending along perimeter edges of the opening at each longitudinal end of the refuse containment body 100. For example, the opposing ends may have holes and mounts so that they may be coupled to a hopper or tailgate using T-nuts. The opposing ends may be coupled to a hopper or tailgate using different methods, for example, one end may be affixed to a hopper using tab-in-slot arrangement, while the opposing end is affixed to a tailgate using cam-locking pins, according to an exemplary embodiment.

In exemplary embodiments, the refuse containment body 100 may be made up of individual panels that are coupled to one another to form a body. Individual panels may be specific to particular refuse vehicles or specific to particular needs. Additionally, the individual panels that comprise the refuse containment body 100 are replaceable. For example, if the floor of a refuse containment body endures more wear than the walls or roof, the flooring may be switched out for a new floor panel more often. In exemplary embodiments, the walling panels may be changed out for taller wall panels, thereby increasing the volume of the refuse containment body 100 according to need and/or desired storage capacity.

Additionally, other body sections or subsections of a body section may be made up of multiple individual panels that are bolted or otherwise mechanically fastened to together. Stated differently, at least one wall section of the body 100 may be formed from multiple panels, and may include one or more removable panels in high wear areas of the vehicle to enable replacement of portions of the wall without replacing the wall in its entirety. For example, the body 100 may include a replaceable panel section adjacent to (or at) at least one of (i) a middle region of the body along which the ejector/packer runs across most frequently, or (ii) a side wall of the body 100 where a more refuse contacts relative to other walls (e.g., a street side wall on a side load refuse vehicle arrangement, etc.).

In some embodiments, the refuse vehicle additionally or alternatively includes components with replaceable structural elements (e.g., structural pieces such as panels supporting mounting hardware, etc.), which can eliminate the need to replace components of the refuse vehicle in their entirety. For example, a lower portion of the headframe of the refuse vehicle supporting cylinders for the pack/eject wall may be formed separately from other regions/walls of the headframe and/or body 100 to enable replacement of high wear components.

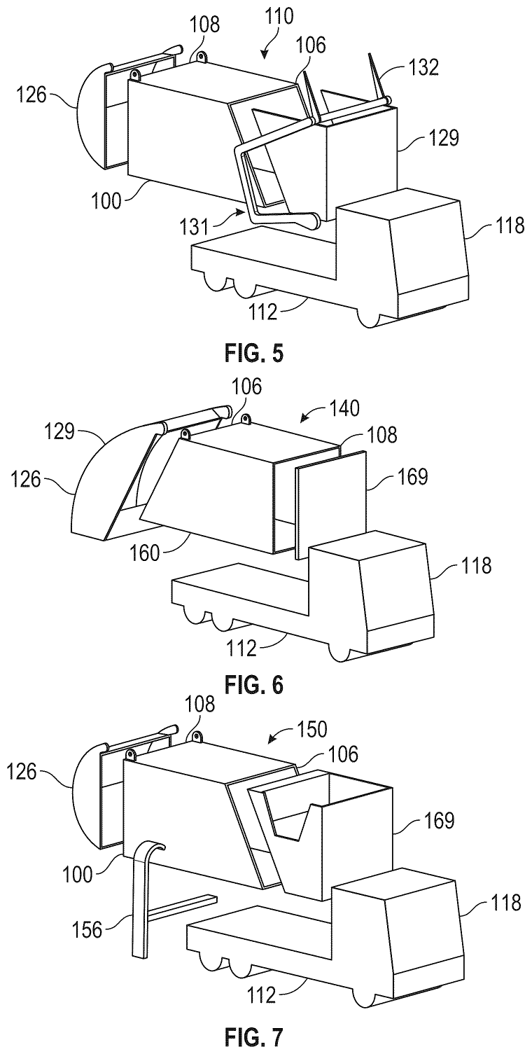

Referring to FIGS. 5-7, exploded views of modular refuse vehicles portrayed in FIGS. 4A, 4B, and 4C are shown according to an exemplary embodiment. These views show the various modular components of side-loading (FIG. 5), front-loading (FIG. 6), and rear-loading (FIG. 7) modular refuse vehicles. The modular refuse vehicles 110, 150, and 160 may include a chassis 112 (e.g., the frame 12), a cab 118 (e.g., cab 18), the refuse containment body 100, a tailgate section 126, a hopper section 129. The refuse containment body 100 contains the hopper mating portion 106 (e.g., a hopper mating opening, etc.) and the containment wall mating portion 108 (e.g., a containment wall mating opening, etc.). The body sections are positioned behind the cab 118 and coupled to the chassis 112. The tailgate section 126 may be structured similarly to tailgate 26, tailgate body 102, or combination thereof. The hopper section 129 may be structured similarly to the hopper volume 29, the hopper volume body 104, or combination thereof. In an exemplary embodiment, the tailgate section 126 and the hopper section 129 are the same structure. A body section or subsections of a body section may be composed of multiple panels bolted together.

### Front-Loading Configuration

Referring to FIG. 5, an exploded perspective view of a front-loading modular refuse vehicle 110 that includes a refuse containment body 100 with a hopper mating portion 106 and a containment wall mating portion 108 according to an exemplary embodiment. The front-loading modular refuse vehicle 110 may be configured similarly to the front-loading refuse vehicle 10. The front-loading modular refuse vehicle 110 additionally includes a lift assembly 131 with lift arms 132 that are configured similarly to the lift assembly 31 and the lift arms 32 of the front-loading refuse vehicle 10. In this embodiment, the refuse containment body 100 is positioned such that the hopper mating portion 106 is facing toward the cab 118. The hopper mating portion 106 and the hopper section 129 may be configured to couple together. The containment wall mating portion 108 and the tailgate section 126 may be configured to couple together.

### Rear-Loading Configuration

FIG. 6 depicts an exploded perspective view of a rear-loading modular refuse vehicle 140 that includes a refuse containment body 100 with a hopper mating portion 106 and a containment wall mating portion 108 according to an exemplary embodiment. The rear-loading modular refuse vehicle 140 may be configured similarly to the rear-loading refuse vehicle 40. The rear-loading modular refuse vehicle 140 additionally includes a containment wall 169, and the tailgate section 126 is configured similarly to the tailgate 26 of the rear-loading refuse vehicle 40. In an exemplary embodiment, the tailgate section 126 is integrated with the hopper section 129 and includes a packer assembly (e.g., packer 44). In this embodiment, the refuse containment body 100 is positioned such that the containment wall mating portion 108 is facing toward the cab 118. In such embodiment, the tailgate section 126 includes an opening and edges of an opening configured with a mating portion to couple with the hopper mating portion 106. The containment wall mating portion 108 and the containment wall 169 may be configured to couple together.

In an exemplary embodiment, the edges of a first opening of the refuse containment body 100 may include a first mating interface such as a T-track and the edges of the tailgate section 126 may include a mating interface such as a hole for a T-nut. Additionally, the shape and dimensions of the first opening and a mating portion of the tailgate section 126 are configured create a compartment. For example, the edges of the first opening may form an outwardly downward slanted opening and the edges of the tailgate section 126 may have an outwardly upward slant. In an exemplary embodiment, the containment wall 169 may be made of multiple panels bolted together.

### Side-Loading Configuration

FIG. 7 depicts an exploded perspective view of a side-loading modular refuse vehicle 150 that includes a refuse containment body 100 with a hopper mating portion 106 and a containment wall mating portion 108, according to an exemplary embodiment. The side-loading modular refuse vehicle 150 may be configured similarly to the side-loading refuse vehicle 50. The side-loading modular refuse vehicle 150 additionally includes a track 156 (e.g., track 56), and the hopper section 129 is configured similarly to the hopper volume 29 of the side-loading refuse vehicle 50. In an exemplary embodiment, the hopper section 129 is configured with a grabber assembly (e.g., grabber assembly 54). In this embodiment, the refuse containment body 100 is positioned such that the hopper mating portion 106 is facing toward the cab 118. The hopper mating portion 106 and the hopper section 129 may be configured to couple together. The containment wall mating portion 108 and the tailgate section 126 may be configured to couple together.

Refuse Vehicles with Volume Expansion Sections

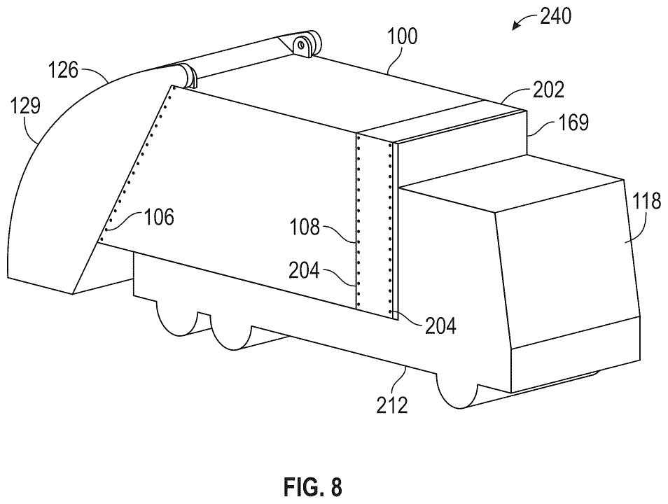

Referring to FIGS. 8-10, three different types of expanded refuse vehicles are shown with a volume expansion section 202. The expanded refuse vehicles may be configured similarly to the refuse vehicles of FIGS. 1-3 or the modular refuse vehicles of FIGS. 4-7. An expanded refuse vehicle may include the chassis 112, the cab 118, the tailgate section 126, the hopper section 129, the refuse containment body 100, the containment wall 169, and a volume expansion section 202 with at least two expansion mating portions 204. A body section or subsections of a body section may be composed of multiple panels bolted together. A volume expansion section 202 may be coupled to one or more mating portions of the refuse containment body 100, the containment wall 169, another body section, or a combination thereof. The volume expansion section 202 may be configured in shape and dimension to create a volume-increased compartment with another body section. A body section or subsections of a body section may be composed of multiple panels bolted together. The volume of the refuse containment body 100 may be increased by adding one or more volume expansion sections, containment wall end, or in-between the two ends of the refuse containment body 100.

The refuse containment body 100 may be coupled to the hull or subframe of a refuse vehicle, according to an exemplary embodiment. In exemplary embodiments, the hull of the refuse vehicle may serve as the floor of the refuse containment body 100. In other embodiments, the hull may serve as the longitudinal frame members of the refuse containment body 100. Additionally, the hull may include vertical members that serve as part of the walls of the refuse containment body 100, according to an exemplary embodiment. In side-loading and front-loading refuse vehicles, the hull or subframe of the refuse vehicle may be capable of supporting the hopper portion of the refuse vehicle.

In exemplary embodiments, the refuse containment body 100 may be made of individual panels or modular elements that are coupled together (e.g. floor, walls, roof). The individual panels may be specific to the type of refuse vehicles. Alternatively, the individual panels may be chosen based on a user's need; for example, based on the weight or the durability of the individual panels. In exemplary embodiments, refuse vehicle tailgates may also be modular. A tailgate may on a refuse vehicle be changed out for a tailgate of larger volume to accommodate more refuse materials. In exemplary embodiments of a rear-loading refuse vehicle, the tailgate and hopper may be modular. The modularity of the rear-loading tailgate and hopper may permit a user to switch the tailgate and hopper for one of different volume, one with a different tag axle, one with a different wall thickness, or one with a different load edge.

### Volume Expansion at an Axial End in a Rear-Loading Configuration

Referring to FIG. 8, perspective view of a rear-loading expanded refuse vehicle 240 with a volume expansion section 202 according to an exemplary embodiment. In this exemplary embodiment, the refuse containment body 100 comprises the containment wall mating portion 108, the volume expansion section 202, and the hopper mating portion. In this embodiment, the hopper mating portion 106 is coupled to a mating portion of the tailgate section 126 section integrated with the hopper section 129 at an axial end, and the containment wall mating portion 108 is coupled with the first expansion mating portion 204 of the volume expansion section 202 at another axial end. In this embodiment, the second expansion mating portion 204 is coupled to the containment wall 169. A volume expansion section 202 coupled at an axial end of a refuse containment body 100 may be configured in a front-loading or side-loading refuse vehicle.

Volume Expansion within a Body in a Rear-Loading Configuration

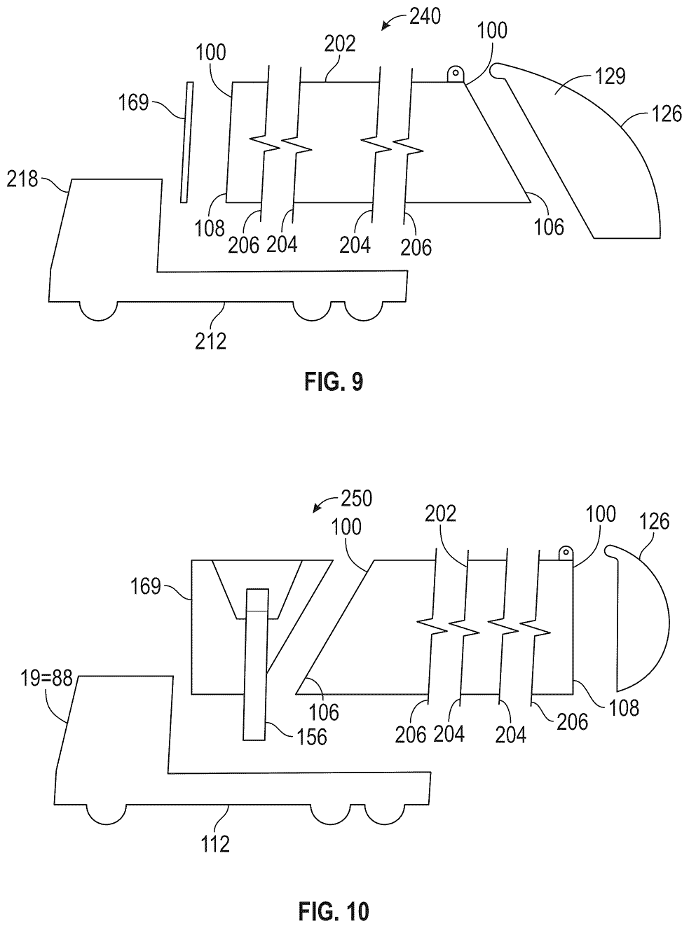

Referring to FIG. 9, an exploded side view of a rear-loading expanded refuse vehicle 240 with a volume expansion section 202 is shown according to an exemplary embodiment. In an exemplary embodiment, the volume expansion section 202 is configured to couple within the refuse containment body 100 instead of at an axial end. The example contained in FIG. 9 depicts the containment wall mating portion 108 and the hopper mating portion 106 integrated into discrete subcomponents of the refuse containment body 100. A subcomponent may include the containment wall mating portion 108 and an internal mating portion 206. The containment wall mating portion 108 couples to the containment wall 169 and the internal mating portion 206 couples to an expansion mating portion 204 of the volume expansion section 202. Similarly, another subcomponent may include the hopper mating portion 106 and an internal mating portion 206. The hopper mating portion 106 couples to the tailgate section 126 integrated with the hopper section 129 and an expansion mating portion 204 of the volume expansion section 202. In this exemplary embodiment, the volume expansion section 202 is integrated within the refuse containment body 100. The subcomponents may each be a single panel, or multiple panels fastened together.

Volume Expansion within a Body in a Side-Loading Configuration

Referring to FIG. 10, exploded side view of a side-loading refuse vehicle rear-loading refuse vehicle 250 with a volume expansion section 202 is shown according to an exemplary embodiment. In an exemplary embodiment, the volume expansion section 202 is configured to couple within the refuse containment body 100 instead of at an axial end. The example contained in FIG. 10 depicts the containment wall mating portion 108 and the hopper mating portion 106 integrated into discrete subcomponents of the refuse containment body 100. A subcomponent may include the containment wall mating portion 108 and an internal mating portion 206. The containment wall mating portion 108 couples to the tailgate section 126 and the internal mating portion 206 couples to an expansion mating portion 204 of the volume expansion section 202. Similarly, another subcomponent may include the hopper mating portion 106 and an internal mating portion 206. The hopper mating portion 106 couples to the hopper section 129 and an expansion mating portion 204 of the volume expansion section 202. In this exemplary embodiment, the volume expansion section 202 is integrated within the refuse containment body 100. The subcomponents may each be a single panel, or multiple panels fastened together.

Refuse Vehicles with Modular Ejectors

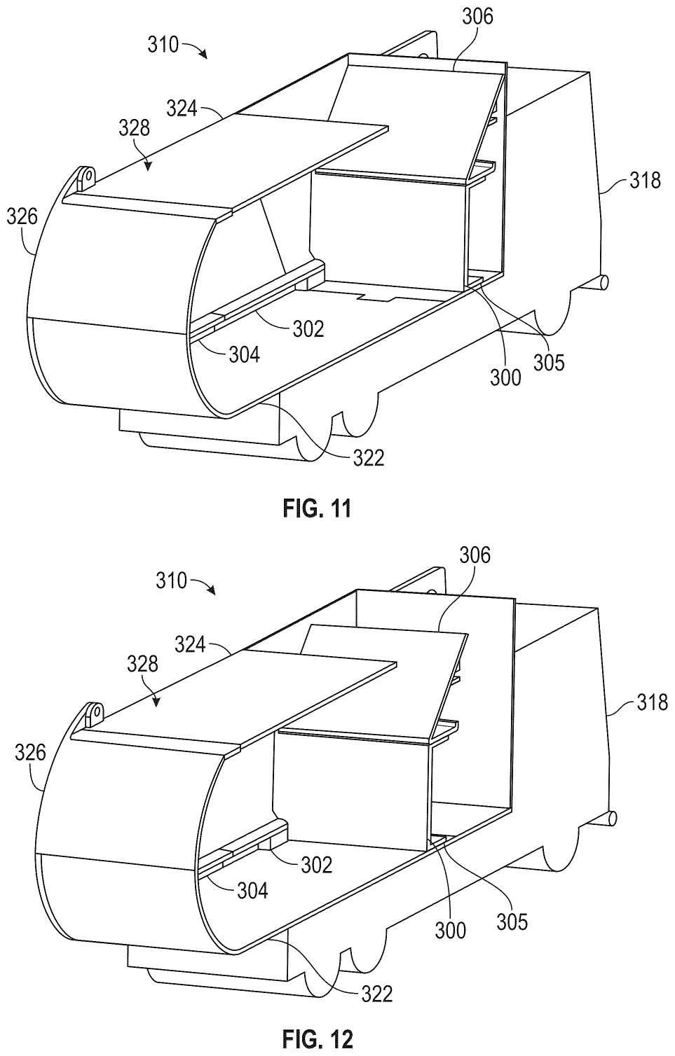

Referring to FIGS. 11-20, a modular ejector assembly may be configured for use within the refuse vehicles of FIGS. 1-3, the modular refuse vehicles of FIGS. 4-7, and the expanded refuse vehicles 8-10. The modular ejector assembly includes a common modular ejector 300 and an engaging track 309. A common modular ejector 300 includes a common eject base 305 and a top panel. The top panel may be configured as a fixed top panel 306, a curved top panel 307, or a follower panel 308. The top panel is fastened to a top of the common eject base 305. A bottom of the common eject base 305 is configured with an engaging member (e.g., grooves, wheels, treads, runners, cogs, guides, rails, shoes, etc.) that permit the common eject base to move along the engaging track 309. The engaging track 309 may be configured as a packer shoe track 302, an ejector shoe track 303, or a shoe track 304. In exemplary embodiments, multiple discrete engaging tracks 309 (e.g., engaging track sections) may be constructed in series to construct a longer engaging track 309. Each discrete engaging track 309 may have aligning features 311 to facilitate the construction of the longer engaging track 309. An aligning feature 311 may be configured with previously mentioned mechanical mechanisms (e.g., for coupling, mating, or sealing), structural positioning features (e.g., pins, holes, protrusions, grooves, etc.), or combination thereof.

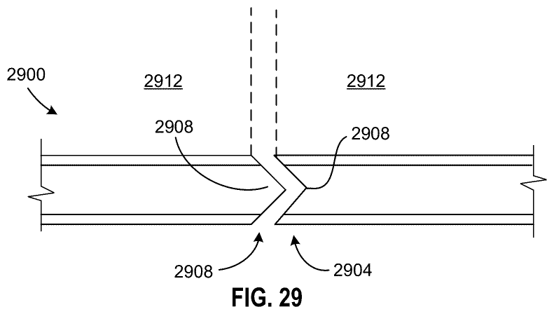

For example, and referring to FIG. 29, an engaging track 2900 is shown that includes an alignment feature in the form of a notch 2902 at a first end 2904 thereof, and a protrusion 2906 at a second end 2908 opposite the first end 2904. The protrusion 2906 is configured to nestably engage with the notch 2902 and to guide different sections of engaging track 2900 into alignment with one another during assembly. A cross-sectional profile of the protrusion 2906, viewed normal to a guide direction of the engaging track 2900 (e.g., from the side of the engaging track 2900 as shown in FIG. 29), matches a cross-sectional profile of the notch 2902. In the embodiment of FIG. 29, the protrusion 2906 is a “V” shaped protrusion that tapers to an outer end 2910 of the protrusion 2906. In other embodiments, the cross-sectional profile of the notch 2902 and/or the protrusion 2906 may be different (e.g., a “U” shaped profile or another curved profile, etc.). In some embodiments, the engaging track 2900 includes multiple alignment features along different axis directions (e.g., a first “V” shaped notch defined by an upper wall of the engaging track 2900, a second “V” shaped notch defined by a side wall of the engaging track 2900, etc.). Such an arrangement can, beneficially, facilitate alignment between track sections and/or between panels 2912 that are coupled to the engaging tracks 2900, during assembly.

The location of the alignment features may be different in various embodiments. For example, in some embodiments, the alignment feature is at least partially defined by a side wall panel of the body assembly, such as between a tapered edge of the engaging track 2900 and the side wall panel, etc.). In some embodiments, the alignment features may be disposed on the panels 2912 of the body assembly instead of, or in addition to, the engaging tracks 2900.

Referring again to FIG. 20, the engaging track 309 may be positioned inside a refuse compartment 328 (e.g., refuse compartment 28, refuse containment body 100, etc.) of a refuse vehicle. The refuse compartment 328 is formed by panels 322, a cover 324, and a tailgate 326. In an exemplary embodiment, the engaging track 309 may be located inside at a corner of the refuse compartment 328. In some embodiments, the engaging track 309 runs along the longitudinal length of the refuse compartment 328 permitting the common modular ejector 300 to move a length between the tailgate 326 and a front of the body assembly (e.g., a front of the body assembly adjacent to a cab 318 (e.g., cab 18 or cab 118)). The engaging track 309 may be bolted or fastened to the body 100 using another type of mechanical fastener, thereby permitting removal and replacement of the engaging track 309 and/or sections thereof separately from other components of the body 100.

In exemplary embodiments, the engaging track 309 in the hopper portion of a refuse vehicle may be formed separately from the engaging track 309 in the containment portion of the refuse vehicle. The engaging track 309 may be made of different materials to account for different wear needs, and may be replaced more or less frequently than other components of the refuse vehicle depending on wear needs.

### Front-Loading Configuration

Referring to FIG. 11 and FIG. 12, front-loading refuse vehicles 310 with a modular ejector assembly are shown according to an exemplary embodiment. FIG. 11 depicts a perspective internal view of a front-loading refuse vehicle 310 equipped with a modular ejector assembly according to an exemplary embodiment. In this embodiment, the fixed top panel 306 is mounted on the common eject base 305. The common eject base 305 is adjustably connected to the wall of the front-loading refuse vehicle 310 and an engaging track 309. The packer shoe track 302 and the ejector shoe track 303 are shown in the exemplary embodiments as being coupled to the internal wall and floor of the refuse vehicle. The packer shoe track 302 and ejector shoe track 303 permit for internal members of the refuse compartment 328 to be moved along the engaging tracks 309. Internal members may include the common modular ejector 300 and refuse. For example, FIG. 12 depicts a perspective internal view of a front-loading refuse vehicle 310 equipped with a modular ejector assembly in a retracted position according to an exemplary embodiment. The common eject base 305 and the fixed top panel 306 may slide along the packer shoe track 302 to compact the refuse materials collected by front-loading refuse vehicle 310. In alternative embodiments, the fixed top panel 306 includes a full height adapter, which may adjust an opening through which loose refuse may be loaded into the refuse compartment (e.g. refuse compartment 28).

### Rear-Loading Configuration

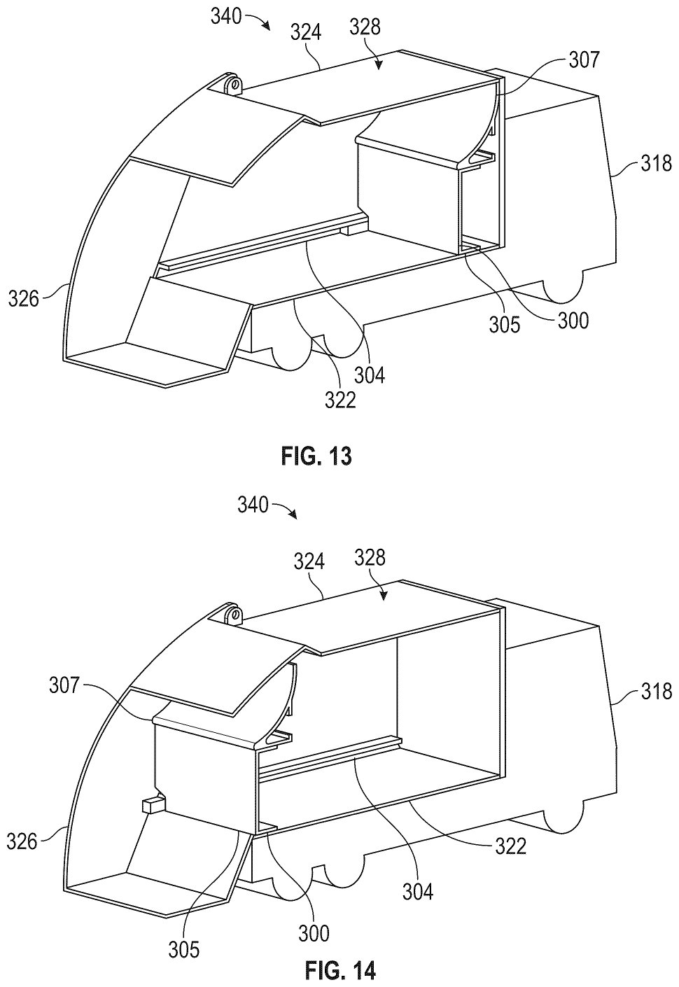

Referring to FIG. 13 and FIG. 14, rear-loading refuse vehicles 340 with a modular ejector assembly are shown according to an exemplary embodiment. FIG. 13 depicts a perspective internal view of a rear-loading refuse vehicle 340 equipped with a modular ejector assembly according to an exemplary embodiment. In this embodiment, the curved top panel 307 is mounted on the common eject base 305. The common eject base 305 is adjustably connected to the wall of a shoe track 304. A shoe track 304 is shown in the exemplary embodiments as being coupled to the internal wall and floor of the refuse vehicle. The shoe track 304 permits for internal members of the refuse compartment 328 to be moved along the engaging tracks 309. For example, FIG. 14 depicts a perspective internal view of a rear-loading refuse vehicle 340 equipped with a modular ejector assembly in a retracted position according to an exemplary embodiment. The common eject base 305 and the curved top panel 307 slide along the shoe track 304 to eject refuse materials from the rear-loading refuse vehicle 340. In exemplary embodiments, the curved top panel 307 includes a cylinder mount for a rear-loading refuse vehicle ejection cylinder.

### Side-Loading Configuration

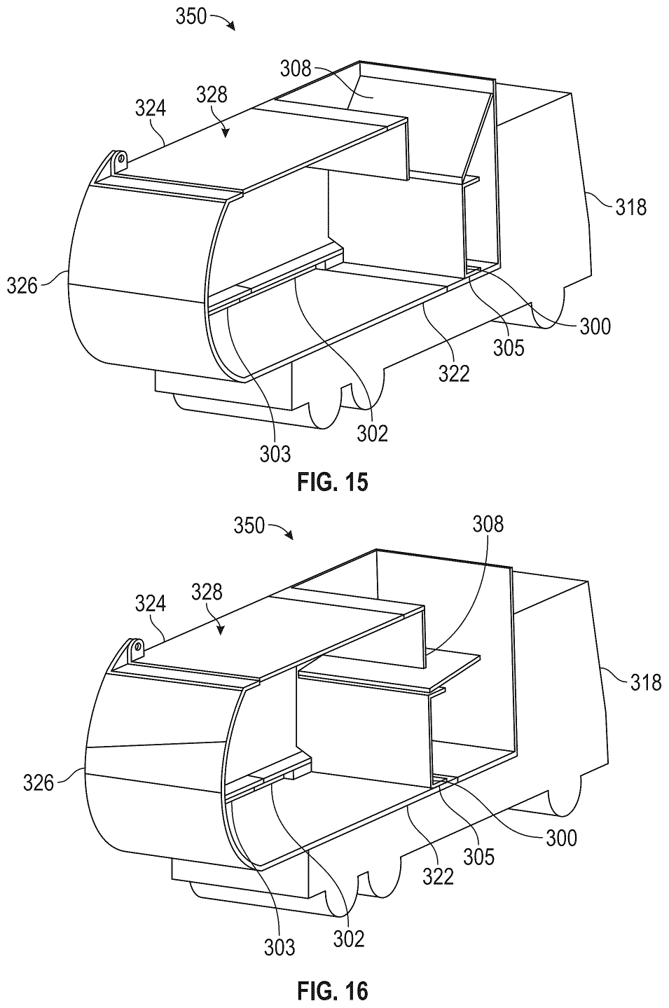

Referring to FIG. 15 and FIG. 16, side-loading refuse vehicles 350 with a modular ejector assembly are shown according to an exemplary embodiment. FIG. 15 depicts a perspective internal view of a side-loading refuse vehicle 350 equipped with a modular ejector assembly according to an exemplary embodiment. In this embodiment, the follower panel 308 is mounted on the common eject base 305. The common eject base 305 is adjustably connected to the wall of the refuse vehicle. The packer shoe track 302 and the ejector shoe track 303 are shown in the exemplary embodiments as being coupled to the internal wall and floor of the refuse vehicle. The packer shoe track 302 and the ejector shoe track 303 permit for internal members of the refuse compartment 328 to be moved along the engaging tracks 309. For example, FIG. 16 depicts a perspective internal view of a side-loading refuse vehicle 350 equipped with a modular ejector assembly in a retracted position according to an exemplary embodiment. The common eject base 305 and the mounted follower panel 308 slide along the packer shoe track 302 to make additional space within the side-loading refuse vehicle hopper while it is being packed with refuse materials. The follower panel 308 may fold down to accommodate sliding the common eject base 305 along the packer shoe track 302.

### Modular Ejector Components

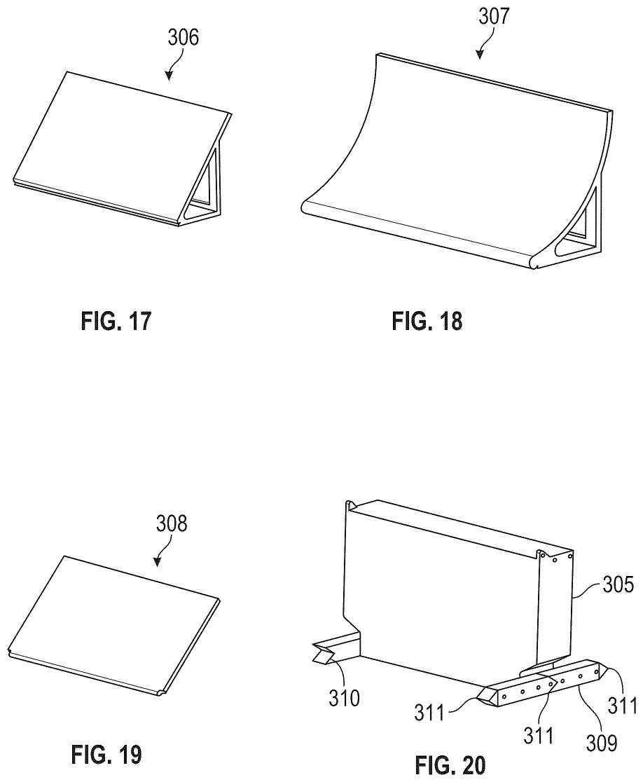

Referring to FIGS. 17-20, a perspective view of the various types of common panels (e.g. fixed top panel 306, curved top panel 307, follower panel 308) and the common eject base 305. FIG. 17 shows a perspective view of a fixed top panel 306 for a front-loading refuse vehicle 310 (e.g., such as those depicted in FIGS. 11-12) according to an exemplary embodiment. The fixed top panel 306 comprises a straight panel and supporting brackets that fix the straight panel at an angle from a top surface of the common eject base 305 when the fixed top panel 306 is affixed to the top of the common eject base 305. The angle from the top surface of the common eject base 305 may be from zero to ninety degrees. FIG. 18 shows a perspective view of a curved top panel 307 for a rear-loading refuse vehicle 340 (e.g., such as those depicted in FIGS. 13-14) according to an exemplary embodiment. The curved top panel 307 comprises a curved panel and supporting brackets that fix the curved panel at an angle from a top surface of the common eject base 305 when the curved top panel 307 is affixed to the top of the common eject base 305. FIG. 19 shows a perspective view of a follower panel 308 for a side-loading refuse vehicle 350 (e.g., such as those depicted in FIGS. 15-16) according to an exemplary embodiment. The curved top panel 307 comprises a straight panel that is hingedly fixed to the top of the common eject base 305. An angle from a top surface of the common eject base 305 may vary during operation. FIG. 20 shows a perspective view of a common eject base 305 coupled to engaging tracks 309, according to an exemplary embodiment. In exemplary embodiments, the engaging track 309 comprises a series of tracks and each track may include an aligning feature 311. For example, in FIG. 20, some tracks include a protrusion, and tracks include a groove that engage with the protrusion. When the protrusion and groove engage, a series of tracks may be aligned to form the engaging track 309.

### Coupling Mechanisms for Refuse Vehicles

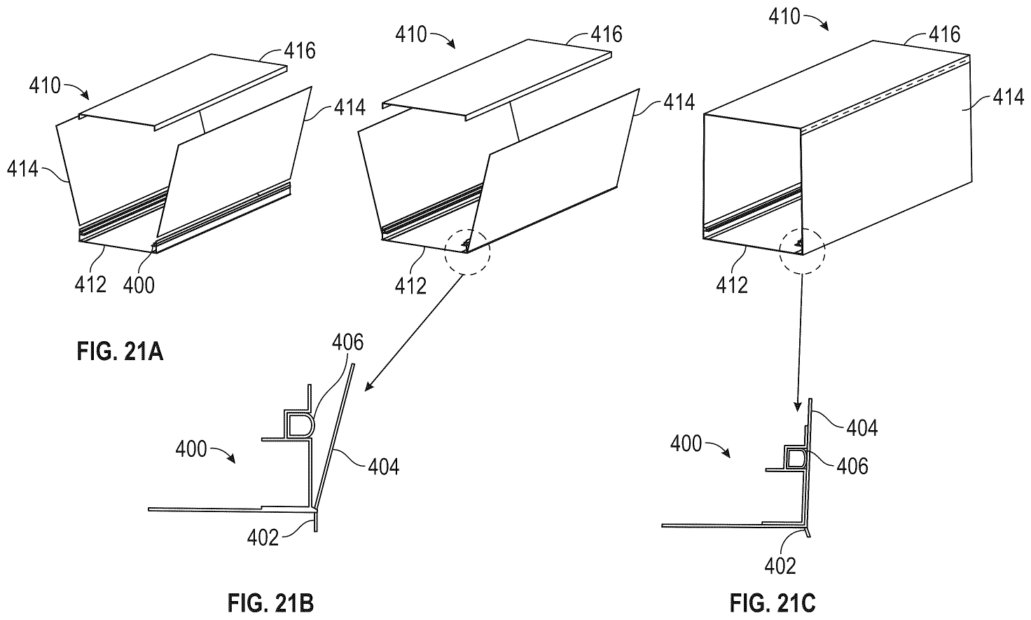

Referring to FIGS. 21-26, coupling mechanisms for construction of the refuse vehicle is shown according to an exemplary embodiment. The coupling mechanisms may be used for coupling, mating, fastening, or other joining of refuse vehicle components, including body sections, subsections, subcomponents, etc. For example, a body section (e.g. (e.g., cab 18, on-board receptacle 16, tailgate 26, refuse compartment 28, etc.) may be mated to another body section, coupled to a chassis, or coupled together from subsections or subcomponents. Coupling mechanisms may include bolts, rivets, adhesive, weld, T-Nuts, formed tab-in-slot, latches, locks, deformable tabs, keyways/keyed, pins, cam-locking pins, or any combination thereof.

### Refuse Containment Assembly

Referring to FIGS. 21A-C, a diagram detailing the assembly of refuse containment body 410 using formed tab-in-slot, according to an exemplary embodiment. A refuse containment body 410 may be configured as a component of the refuse vehicles, the modular refuse vehicle, or the expanded refuse vehicle. The refuse containment body 410 may include a floor 412, walls 414, and a roof 416. FIG. 21A shows a perspective view of a refuse containment body 410 during a first phase of assembly using a tab-and-slot arrangement according to an exemplary embodiment. In exemplary embodiments, the floor 412 and/or roof 416 may include sections of tab-in-slot 400. FIG. 21B shows a perspective view of the refuse containment body 410 of FIG. 21A in a second phase of assembly, according to an exemplary embodiment, which involves connecting walls 414 to floor 412 and/or roof 416 using tab-in-slot 400. FIG. 21B further shows a closeup side view of tab-in-slot 400. In an exemplary embodiment, tab-in-slot 400 include a tab 402, a compressible seal 406, and a tipping wall 404. In the exemplary embodiment shown in FIG. 21B, the tipping wall 404 is in a non-vertical open position, the tab 402 is nonplanar to the floor 412 or roof 416 of the refuse containment body 410, and the seal 406 is uncompressed. FIG. 21C shows a perspective view of the refuse containment body 410 of FIG. 21A in a third phase of assembly, according to an exemplary embodiment, which involves coupling the walls 414 to the roof 416 and floor 412 using tab-in-slot 400. FIG. 21C further shows a closeup side view of tab-in-slot 400. In the exemplary embodiment shown in FIG. 21C, the tipping wall 404 is in a vertical closed position, the tab 402 is planar to the floor 412 or roof 416 of the refuse containment body 410, and the seal 406 is compressed.

### Deformable Tabs

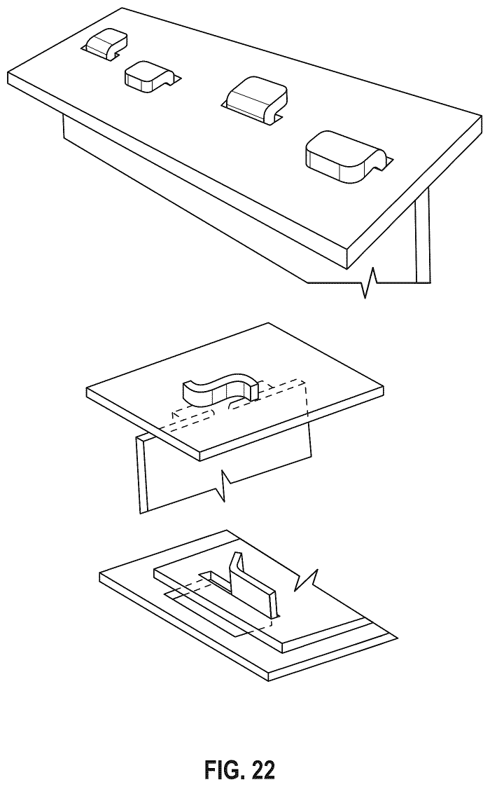

Referring to FIG. 22, a perspective view of a deformable tab structure used to couple body sections is shown according to an exemplary embodiment. For example, the deformable tabs may be used in the hopper mating portion 106 to couple the refuse containment body 100 to the hopper section 129. Additionally, the deformable tabs may be used in the containment wall mating portion 108 to couple the refuse containment body 100 to the containment wall 169 or the tailgate 34 of a refuse vehicle. In exemplary embodiments, deformable tabs are used in the expansion mating portions 204 to couple the volume expansion section 202 to the hopper section 129 or the containment wall mating portion 108, volumetrically expanding the refuse containment body 100. In alternative embodiments, deformable tabs may be used in the expansion mating portions 204 to couple the volume expansion section 202 to the refuse containment body 100 and the containment wall 169.

T-Nut Assembly

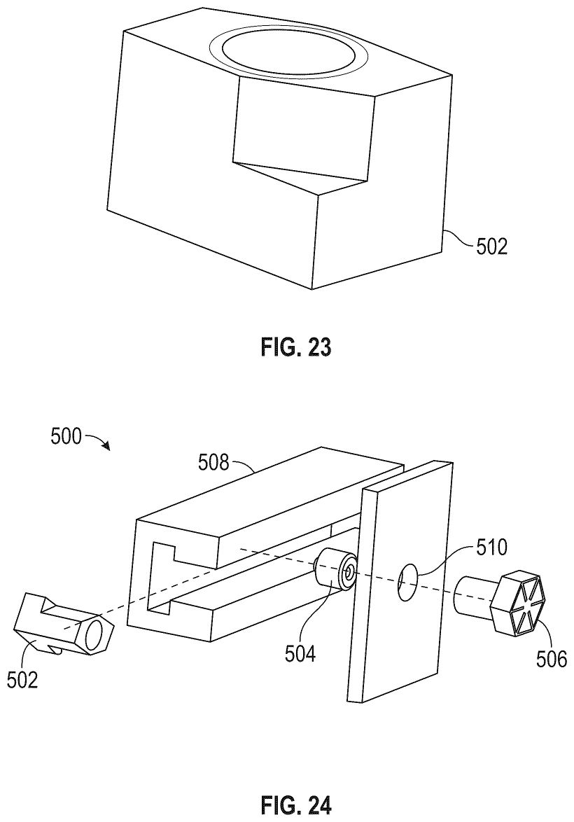

Referring to FIGS. 23-26, a T-nut assembly 500 that may be used as a couple mechanism is shown according to an exemplary embodiment. FIG. 23 depicts a perspective view of a drop-in style T-nut assembly 500 for coupling according to an exemplary embodiment. FIG. 24 shows perspective view of an assembly for coupling using T-nuts according to an exemplary embodiment. This exemplary embodiment contains a slide in T-nut 502, which may be inserted into a T-track 508. The T-nut 502 may be moved along the inside of the T-track 508. A screw cap 506 may be inserted through a hole 510 in the walling of a modular body component, according to an exemplary embodiment. A set screw 504 may be screwed into the T-nut 502 to hold the T-nut 502 in place during assembly.

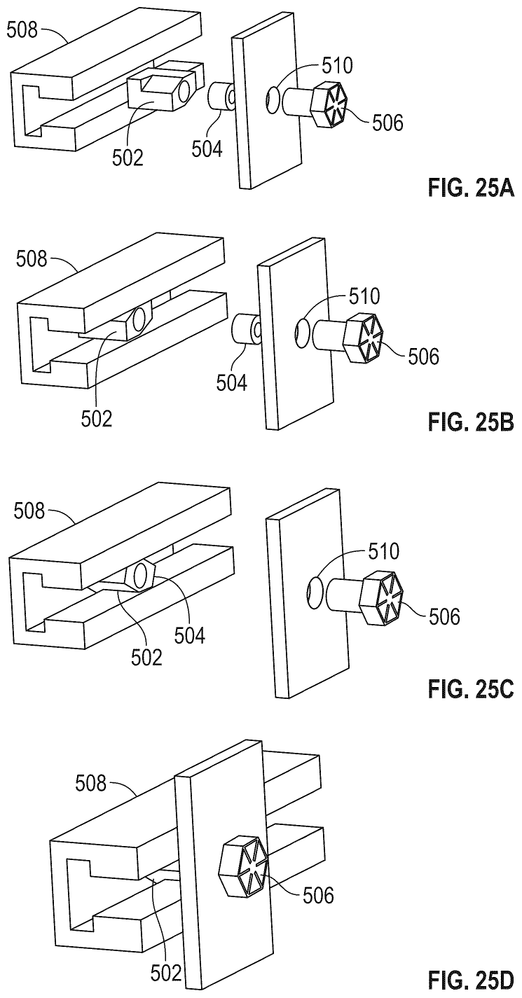

Referring to FIGS. 25A-25D, an exemplary process for assembling a T-nut assembly 500 is shown. FIG. 25A shows a perspective view of a T-nut assembly 500 in a first phase of assembly according to an exemplary embodiment. FIG. 25A may be the same or substantially similar to FIG. 24. FIG. 25B shows a perspective view of a T-nut assembly 500 in a second phase of assembly, in which a T-nut 502 is inserted into a T-track 508. FIG. 25C shows a perspective view of a T-nut assembly 500 in a third phase of assembly, in which a set screw 504 is screwed into a T-nut 502 to keep it in place on a T-track 508 during the assembly process according to an exemplary embodiment. FIG. 25D shows a perspective view of a T-nut 502 assembling in a fourth phase of assembly, in which a screw cap 506 is inserted through a hole 510 in the walling of a refuse vehicle component according to an exemplary embodiment.

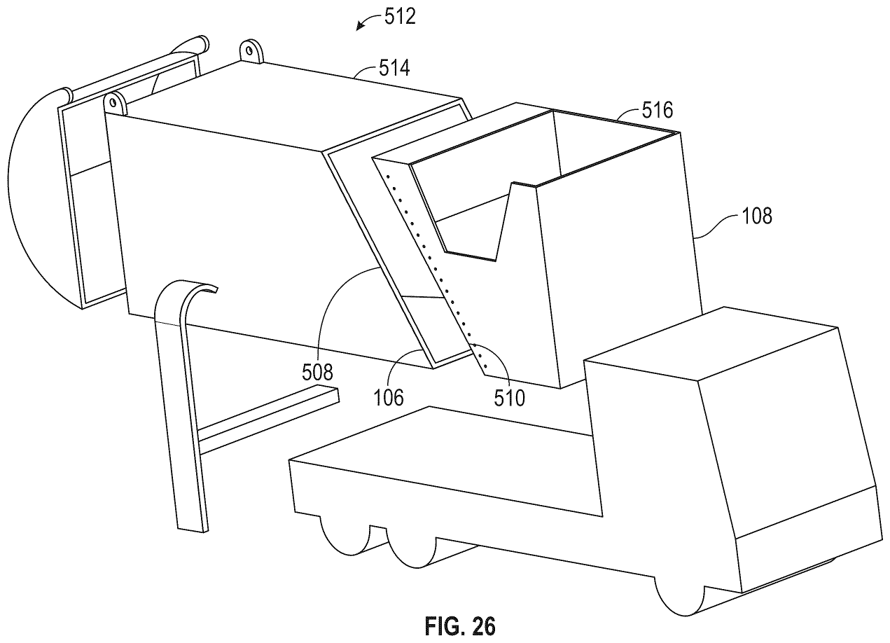

Referring to FIG. 26, an exploded perspective view of a refuse vehicle 512 containing T-tracks 508 and holes 510 for securing a refuse containment body 514 to a hopper section 516 is shown according to an exemplary embodiment. In this exemplary embodiment, a T-track 508 is integrated into to the hopper mating portion 106 of a refuse containment body 514 and a series of the holes 510 is integrated into the mating portion of a hopper section 516. Using the process of assembling the T-nut assembly 500, the refuse containment body 514 is coupled to the hopper section 516.

### Sealing Mechanisms for Refuse Vehicles

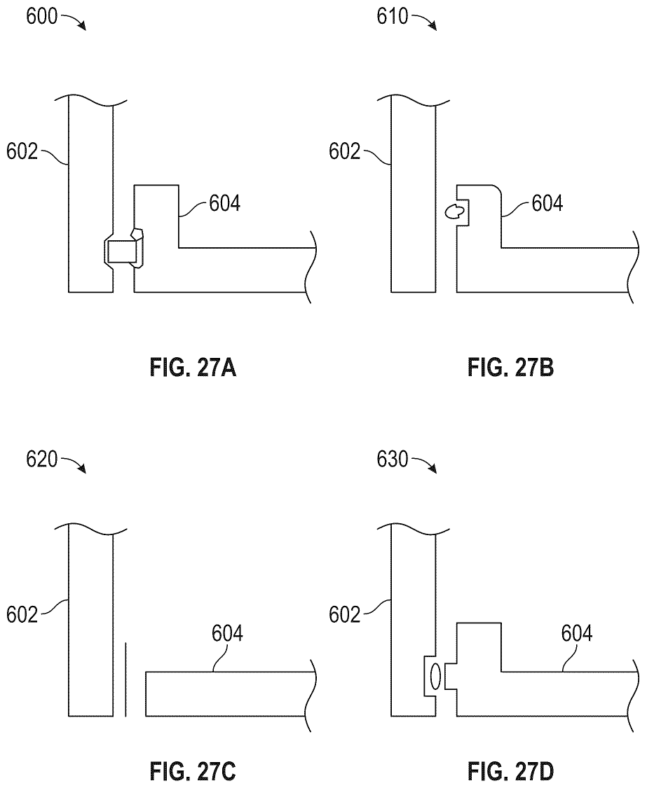

Referring to FIG. 27A-D, side views of mechanisms to seal coupled refuse vehicle components are shown. The sealing mechanisms may be integrated into a first body section 602 and a second body section 604.

FIG. 27A shows a side view of a double-sided groove weld 600 to seal a coupling between the first body section 602 and the second body section 604 according to an exemplary embodiment. In such embodiment, the first body section 602 and the second body section 604 each include a groove. The grooves are lined up and the first body section 602 and the second body section 604 are welded together at the grooves. FIG. 27B shows a side perspective of a single-sided groove weld 610 to seal a coupling between the first body section 602 and the second body section 604 according to an exemplary embodiment. In such embodiment, the second body section 604 includes a groove. The first body section 602 and the second body section 604 are lined up and welded together at the groove. FIG. 27C shows a side view of a gasket weld 620 to seal a coupling between the first body section 602 and the second body section 604 once aligned according to an exemplary embodiment. FIG. 27D shows a side view of a tongue and groove joint 630 to seal a coupling between the first body section 602 and the second body section 604 according to an exemplary embodiment. In such embodiment, the first body section 602 includes a groove, and the second body section 604 includes a protrusion, or tongue. Once the tongue is inserted into the groove, the first body section 602 and the second body section 604 are welded together at the groove.

### Assembly of Refuse Vehicle

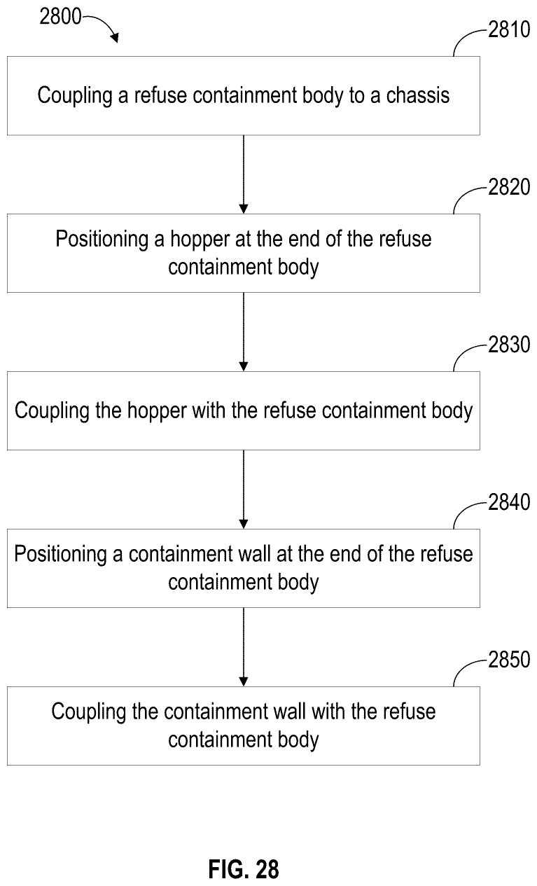

FIG. 28 shows a flowchart of a process 2800 of assembling a refuse vehicle according to an exemplary embodiment. At step 2810, a refuse containment body, or a first body section, is coupled to a chassis, or frame, of a refuse vehicle. The refuse containment body may be a refuse compartment, other body section, or volume. The reuse containment body may be coupled to the chassis by various fastening, coupling, or mating mechanisms. At step 2820, a hopper, or a second body section, is positioned at a first axial end of the containment body. At step 2830, the hopper, or the second body section, is coupled with the refuse containment body. The coupling may include coupling a mating interface of the second body section to the refuse containment body. At step 2840, a containment wall, or a third body section, is positioned at a second axial end of the refuse containment body. The second axial end may be opposite the first axial end along the longitudinal axis of the refuse containment body. At step 2850, the containment wall, or the third body section, is coupled with the refuse containment body. In an exemplary embodiment, process 2800 includes assembling a series of panels to form various walls (e.g., floor, cover, sidewalls, etc.) of the refuse containment body or other body section. In an exemplary embodiment, each coupling may also include sealing the body sections together by a sealing mechanism.

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to permit a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that the terms “exemplary” and “example” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like, as used herein, mean the joining of two members directly or indirectly to one another. Such joining may be stationary (e.g., permanent, etc.) or moveable (e.g., removable, releasable, etc.). Such joining may be achieved with the two members, or the two members and any additional intermediate members being integrally formed as a single unitary body with one another or with the two members or the two members and any additional intermediate members being attached to one another.

References herein to the positions of elements (e.g., “top,” “bottom,” “above,” “below,” “between,” etc.) are merely used to describe the orientation of various elements in the figures. It should be noted that the orientation of various elements may differ according to other exemplary embodiments, and that such variations are intended to be encompassed by the present disclosure.

Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, Z, X and Y, X and Z, Y and Z, or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

It is important to note that the construction and arrangement of the systems as shown in the exemplary embodiments is illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. It should be noted that the elements and/or assemblies of the components described herein may be constructed from any of a wide variety of materials that provide sufficient strength or durability, in any of a wide variety of colors, textures, and combinations. Accordingly, all such modifications are intended to be included within the scope of the present inventions. Other substitutions, modifications, changes, and omissions may be made in the design, operating conditions, and arrangement of the preferred and other exemplary embodiments without departing from scope of the present disclosure or from the spirit of the appended claims.

What is claimed is:

1. A refuse vehicle comprising:
a chassis; and
a refuse containment body coupled to the chassis, the refuse containment body comprising:
a first body section defining a compartment with a first opening at a first axial end of the refuse containment body, and a second opening at a second axial end of the refuse containment body opposite the first axial end; and
a second body section coupled to the first body section at the first opening and extending axially from the first body section, the second body section defining at least one of (i) a hopper opening along a sidewall thereof, or (ii) a volume expansion that extends from the compartment.

2. The refuse vehicle of claim 1, further comprising a first mating interface positioned along a first edge of the first opening of the first body section.

3. The refuse vehicle of claim 2, further comprising a second mating interface positioned along a second edge of the second opening of the first body section.

4. The refuse vehicle of claim 1, wherein the refuse containment body further includes a third body section coupled to the first body section at the second opening and extending axially from the first body section, the third body section defining at least one of (i) a hopper opening along a sidewall thereof, (ii) a volume expansion that extends from the compartment, or (iii) a tailgate section that closes the second opening.

5. The refuse vehicle of claim 1, wherein the first body section further comprises a floor, a cover, and a plurality of sidewalls coupled together to define the compartment.

6. The refuse vehicle of claim 5, wherein one of (i) the floor, (ii) the cover, or (iii) a sidewall of the plurality of sidewalls further comprises a plurality of panels coupled together.

7. The refuse vehicle of claim 2, wherein the second body section further includes a third mating interface configured to form a mating mechanism when coupled with the first mating interface of the first body section.

8. The refuse vehicle of claim 6, wherein a first panel of the plurality of panels comprises a first track and a second panel of the plurality of panels comprises a second track.

9. The refuse vehicle of claim 8, wherein the first track includes a first aligning feature configured to engage with a second aligning feature of the second track to align the first track to the second track when the first panel couples to the second panel.

10. A refuse containment body comprising:
a first body section comprising a plurality of panels coupled together to form a compartment with a first opening and second opening;
a support element coupled to the first body section and configured to mount the first body section to a vehicle chassis;
a first mating interface positioned along a first edge of at least one of the plurality of panels at the first opening of the compartment and configured to couple the first body section to a second body section, and
a second mating interface positioned along a second edge of at least one of the plurality of panels at the second opening of the compartment and configured to couple the first body section to a third body section,
wherein the plurality of mating interfaces includes the first mating interface and the second mating interface, each mating interface of the plurality of mating interfaces is a complement in a mating mechanism.

11. The refuse containment body of claim 10, wherein the second body section comprises at least one of (i) a hopper opening along a sidewall thereof, or (ii) a volume expansion that extends from the compartment.

12. The refuse containment body of claim 10, wherein the third body section comprises at least one of (i) a hopper opening along a sidewall thereof, (ii) a volume expansion that extends from the compartment, or (iii) a tailgate section that closes the second opening.

13. The refuse containment body of claim 10, wherein two or more panels of the plurality of panels forms one of (i) a floor, (ii) a cover, or (iii) a sidewall of the first body section.

14. The refuse containment body of claim 10, wherein the plurality of mating interfaces further includes a third mating interface positioned on the second body section and configured to form the mating mechanism when coupled with the first mating interface of the first body section.

15. The refuse containment body of claim 10, wherein a first panel of the plurality of panels comprises a first track and a second panel of the plurality of panels comprises a second track.

16. The refuse containment body of claim 15, wherein the first track includes a first aligning feature that configured to engage with a second aligning feature of the second track to align the first track to the second track when the first panel couples to the second panel.

17. A method of assembling a refuse vehicle comprising:
coupling a refuse containment body to a chassis, wherein the refuse containment body includes a first axial end with a first mating interface and a second axial end with a second mating interface;
positioning a hopper at the first axial end of the refuse containment body, wherein the hopper includes a hopper opening along a sidewall thereof and a third mating interface; and
coupling the third mating interface of the hopper with the first mating interface of the refuse containment body.

18. The method of claim 17, further including coupling a plurality of panels to form one of (i) a floor, (ii) a cover, or (iii) a sidewall of the refuse containment body.

19. The method of claim 17, further including positioning a body section at the second axial end of the refuse containment body, wherein the body section comprises: at least one of (i) a hopper opening along a sidewall thereof, (ii) a volume expansion that extends from the refuse containment body, or (iii) a tailgate section that closes an opening at the second axial end; and a fourth mating interface.

20. The method of claim 19, further including coupling the fourth mating interface of the body section with the second mating interface of the refuse containment body.
